(19) United States
(12) Patent Application Publication
(10) Pub. No.: US 2016/0156146 A1
(43) Pub. Date: Jun. 2, 2016

(54) TOOL AND METHOD FOR SHAPING A HOLLOW CONDUCTOR BAR

(71) Applicant: ALSTOM TECHNOLOGY LTD, Baden (CH)

(72) Inventor: Immanuel SAFARI-ZADEH, Othmarsingen (CH)

(73) Assignee: ALSTOM TECHNOLOGY LTD, Baden (CH)

(21) Appl. No.: 15/018,206

(22) Filed: Feb. 8, 2016

Related U.S. Application Data
(63) Continuation-in-part of application No. 14/807,935, filed on Jul. 24, 2015.

(30) Foreign Application Priority Data
Aug. 12, 2014 (EP) 14180597.8

(51) Int. Cl. H01R 43/16

(52) U.S. Cl. CPC H01R 43/16

(57) ABSTRACT

The disclosure relates to a tool and a method for shaping a conductor bar for an electric machine and a use of such a tool. Disclosed is a tool for shaping a conductor bar for an electric machine, with a hammer or a movable wheel supported by arms, the hammer or the movable wheel are suitable for engaging and exerting force to the conductor bar to modify the height h and/or the surface structure of the conductor bar, whereas the hammer conducts a bidirectional movement in the axial direction of the tool, whereas the wheel conducts a bidirectional movement in the axial direction of the tool and/or a rotating movement, whereas the tool applies heat to the conductor bar by friction of the hammer or the movable wheel. It is one advantage of the invention that the method and the tool do not remove any material from the conductor bar.

The present disclosure relates to a tool for shaping a conductor bar for an electric machine, a method for shaping a conductor bar for an electric machine, and a use of a tool for shaping a conductor bar for an electric machine.

The electric machine is in particular a rotating electric machine such as a synchronous generator to be connected to a gas or steam turbine (turbogenerator) or a synchronous generator to be connected to a hydro turbine (hydro generator) or an asynchronous generator or a synchronous or asynchronous electric motor, transformers, or also other types of electric machines. For higher power rates, higher than 10 MW, a kind of excitation coil is needed to introduce a rotary magnetic field. Conductor bars of such excitation coils are generally placed into notches or slots of a rotor of an electric machine. The coils or windings consist of a manifold of hollow conductors welded or brazed together to achieve the most compactness. Commonly, winding heads are connected via brazing of two half-windings being connected to a full winding thereby. An alternative design solution is to bend the hollow conductor bars on each edge which inherently demands more space compared to a corner brazed solution.

An object of the invention is to provide a method and a tool to shape conductor bars of a rotor for an electric machine suitable for a space sensitive use at a winding head.

The object is solved with the features of the independent claims. It is one advantage of the invention that the method and the tool do not remove any material from the conductor bar. A further advantage is that any additional brazing or welding intersections and regions are avoided.

Further examples of the invention are disclosed in the dependent claims.

Further characteristics and advantages will be more apparent from the description of a preferred but non-exclusive embodiment of the tool illustrated by way of non-limiting example in the accompanying drawings, in which:

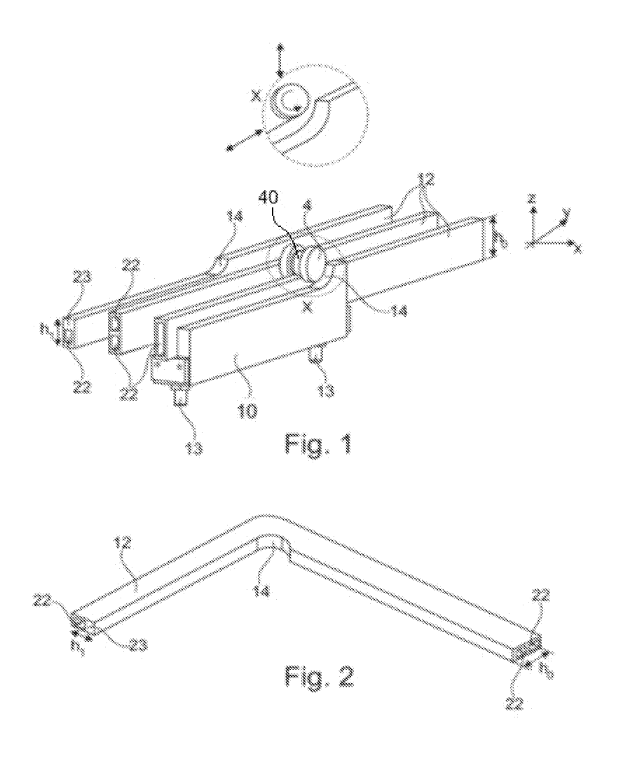

FIG. 1 shows a schematic perspective view of three conductor bars to be shaped, whereas one conductor bar is placed in a support, and a wheel above the conductor bar engaging the conductor bar;

FIG. 2 shows an example of a bent conductor bar which is shaped by a tool with a modified height according to the invention on the left side and not shaped on the right side;

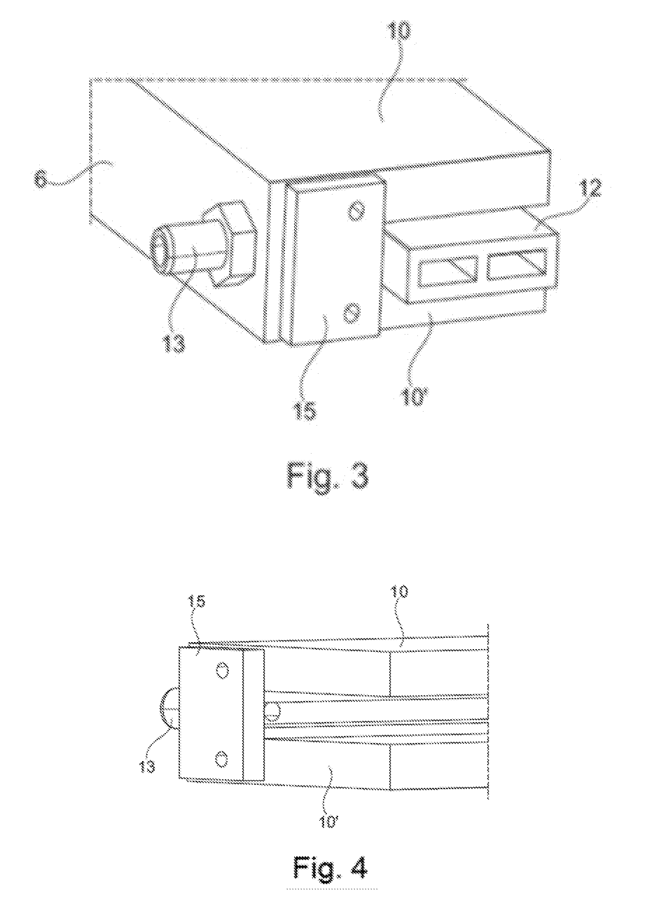

FIG. 3 shows a perspective view of supports with an integrated counterpart and an attached plate, with a conductor bar with a hollow profile to be shaped;

FIG. 4 shows a perspective view according to FIG. 3 from a different perspective without the conductor bar;

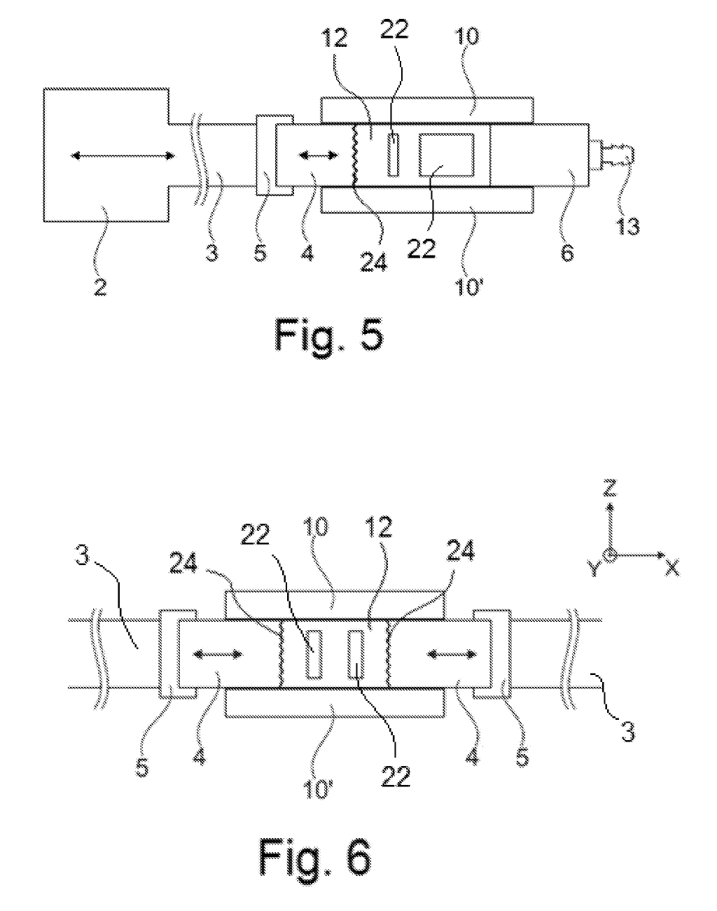

FIG. 5 shows a side view of an example of the tool with a movable grooved wheel supported by an arm engaged to a conductor bar between two supports, and a counterpart;

FIG. 6 is a schematic side view of a conductor bar between two supports, and two grooved wheels engaging the conductor bar from two sides;

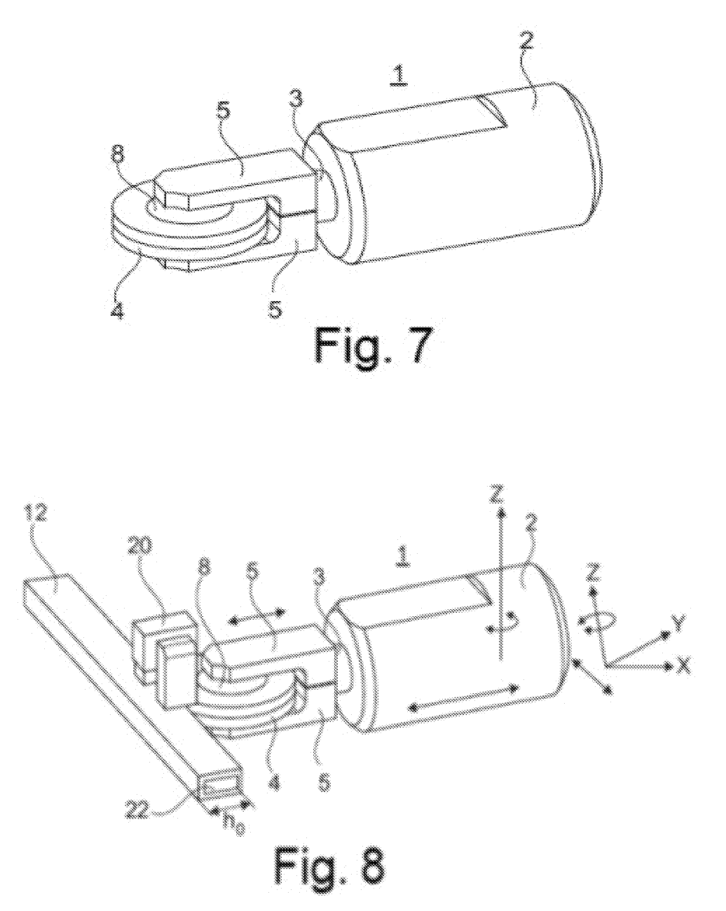

FIG. 7 shows a perspective view of an example of a tool according to the invention with a housing, an u-shaped arm engaging a ceramic ball and a wheel designed around the ceramic ball;

FIG. 8 shows a perspective view similar to FIG. 7 in operation with a conductor bar to be shaped and a heat source to apply heat to the conductor bar;

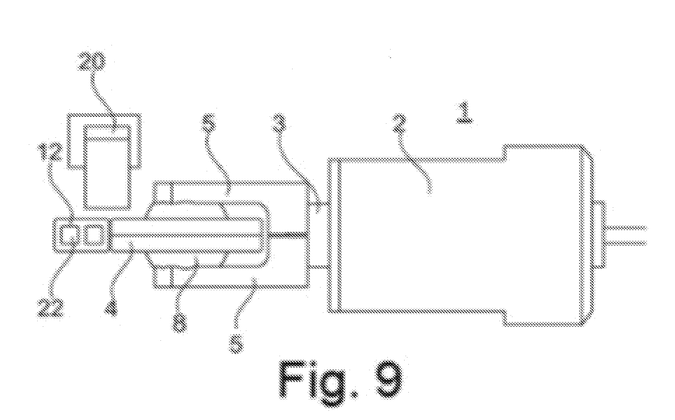

FIG. 9 shows a schematic side view similar to FIG. 8;

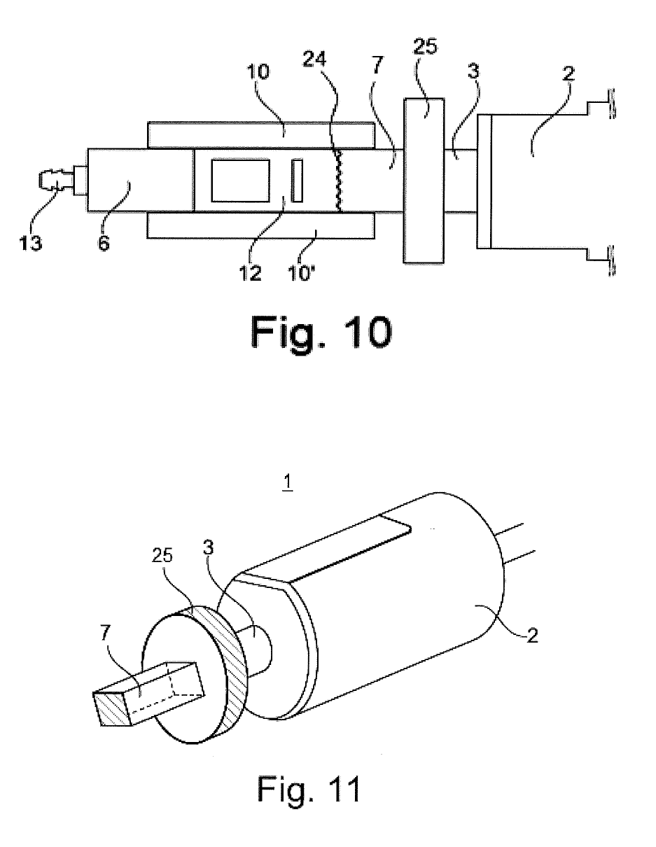

FIG. 10 shows a schematic side view of an alternative example of the invention with a hammer on a disk instead of a wheel designed at one end with a structure of rills to modify the surface structure of the conductor bar;

FIG. 11 shows a schematic perspective view according to FIG. 10;

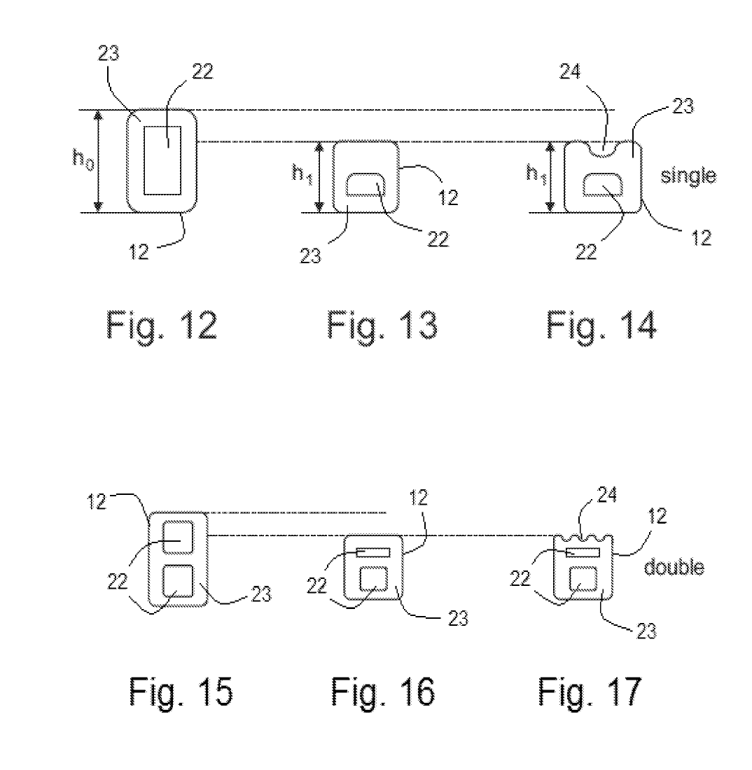

FIG. 12 shows a schematic front view of a conductor bar with a hollow profile before shaping;

FIG. 13 shows a schematic front view of the conductor bar according to FIG. 12 after shaping;

FIG. 14 shows a schematic front view of the conductor bar according to FIG. 12 after shaping with a tool having a structure of rills;

FIG. 15 shows a conductor bar with a hollow profile with two channels before shaping;

FIG. 16 shows a schematic front view of the conductor bar according to FIG. 15 after shaping;

FIG. 17 shows a schematic front view of the conductor bar according to FIG. 15 after shaping with a tool having a structure of rills.

With reference to the figures, these show examples of the invention, wherein like reference numerals designate identical or corresponding parts throughout the several views.

FIG. 1 shows a perspective view to the end of illustrating the principle of the tool 1 and the corresponding method. Shown are three parts of conductor bars 12 or copper conductor bars 12 next to each other. The conductor bars 12 are shown in a cross-section and have usually a length of several metres. The conductor bars 12 hereby are conductor bars 12 of a rotor of a generator to produce power in the range of usually megawatts. In this certain example the rotor conductor bars 12 have hollow profiles which are provided as ducts for a cooling medium to flow through in operation of the generator. The conductor bars 12 are hollow conductors consequently. The disclosed tool 1 and method are preferably suitable for these hollow profiles 22, as it is realized that the shaping of these hollow profiles 22 is feasible with advantageous results. In the FIGS. the conductor bars 12 are removed from the notches or slots of the rotor core for maintenance reasons and are thereby easily accessible. The height h1 of the left conductor bar 12, hereby the size from below to above marked with an arrow, is lower than the height h0 of the conductor bars 12 at the right side. In the top perspective shown the height h is the expansion in the z-direction. The breadth of the conductor bar 12 is not changed as the supports 10, 10′ exert forces from the lower and upper side in this view. The reduction in height h is especially useful as the space for housing the conductor bar 12 in the generator is limited and to be kept small. By application of force to the conductor bar 12 for a certain time it is achieved a reshape of the rotor conductor bar profile. The reshape of the conductor bar 12 is done until the best suitable dimensional match to the foreseen task is achieved. One advantage hereby is that the method and the tool 1 do not remove any material from the conductor bar 12. This means the volume of the conductor bar 12 is reduced without a loss of material. The left conductor bar 12 is shaped by the tool 1 and thereby has a reduced height h0 at the left side. The right conductor bar 12 is placed in a support 10 securely holding the conductor bar 12. A plate 15 finishes the support 11 and serves as a bearing for the conductor bar 12. A feed charge 13 is connected to the support 11. Through the feed charge 13 a cooling medium is passed to cool the conductor bar 14 when shaped. In a schematic way a wheel 4 is shown above the right conductor bar 12, whereas the wheel 4 is a part of a first example of the tool 1 to be described fully below. The tool 1 is suitable to machine several conductor bars 12 at the same time with a corresponding number of wheels 4 or hammers 7 arranged. The wheel 4 can be made from a high tensile steel, ceramics, titanium, a composite material or from a different material except aluminium or copper. In this example the wheel 4 is designed with an inner part having a smaller diameter than the outer part. These parts of the wheel 4 can be made from different materials as listed above. With other words the wheel 4 contains two outer discs and a shaft 40 with a smaller diameter connecting the discs, similar in shape to a cable drum. The wheel 4 is part of the tool 1, driven and operated as is described below. The conductor bar 12 can be fixed at the support 10 or alternatively the conductor bar 12 can be slipped along the support 10. The supports 10, 10′ are designed as rollers in this example. Operating the rollers and rotating the rollers transports the conductor bar 12 in the direction into the image plane. The tool 1 can keep the position in the direction into the image plane in this example. When the conductor bar 12 is fixed and does not move the tool 1 is moved along the length of the conductor bar 12 engaging the upper side of the conductor bar 12. Then, in an example the moving hammer 7 or moving wheel 4, 4′ of the tool 1 is connected to and moved by a robot arm of a robot device along the conductor bar 12. In the alternative, when the conductor bar 12 moves in an axial direction to the centre line the tool 1 does not have to move along the conductor bar 12.

FIG. 2 shows a perspective view of an example of a part of a conductor bar 12 which is partly shaped by a tool 1 according to the invention. At the left side, left from the bending, the conductor bar 12 is shaped and has a reduced height h1 compared to the height h0 of the conductor bar 12 right from the bending. It is visible that the right part of the conductor bar 12 has two hollow chambers and the left shaped part of the conductor bar 12 has only one hollow chamber or hollow profile 22. This means the partition wall within the conductor bar 12 between the two hollow chambers is removed after shaping. One chamber is completely closed by application of heat by a heat source 20 and force resulting in a massive profile 23 with only one hollow chamber. The heat source 20 can be designed as a heater or alternatively the heat is supplied by friction of the hammer 7 or the movable wheel 4 in all examples disclosed. A predefined temperature profile across the conductor bar 12 with a higher temperature on the face of the conductor bar 12 to be shaped avoids undesired side effects. A temperature difference is created between the upper and lower part of the wheel 4 with a higher temperature at the face which adjoins the conductor bar 12. The upper part of the wheel 4 can be cooled to achieve the temperature difference. The pushing force of the wheel 4 on the conductor bar 12 determines the height reduction and the heat-rate supplied by friction. The bending of the conductor bar 12 to approximately 90° has the purpose to use one end of the conductor bar 12 as a so called end winding projecting from a notch or slot in the rotor outwards with a specific angle. The bending can be achieved by different methods. One of these methods is to exert a force by the tool 1 and to conduct the tool 1 along a corresponding curve at the upper side in FIG. 2 with a specific bending degree. The applied force can be variable, altering, or constant. The conductor bar 12 is in this alternative not only reduced in height h but also the shape of the conductor bar 12 is changed to create an angle in the end winding area as shown in FIG. 2.

FIG. 3 shows a perspective view of supports 10, 10′ with an integrated counterpart 6 connected in one piece. The supports 10, 10′ and the counterpart 6 form a u-shape to house the conductor bar 12. The view of FIG. 3 is skipped for 90° to the right, the feeding charge 13 is correspondingly at the left face of the counterpart 6. The plate 15 is fixed by screws to each support 10, 10′ and bridges the supports 10, 10′. The plate 15 has approximately the length of the distance of the outer faces of the two supports 10, 10′, as can be seen in FIG. 3. The plate 15 is suitable for bearing the conductor bar 12 between the supports 10, 10′ during operation of the tool 1.

FIG. 4 shows a perspective view similar to FIG. 3 with the supports 10, 10′ and the counterpart 6 rotated and the plate 15 and the conductor bar 12 removed. Visible is the rectangular recess formed by the supports 10, 10′ below and above and the counterpart 6 behind to include the conductor bar 12.

FIG. 5 is a schematic side view of a further example of a tool 1 according to the invention. The supports 10, 10′ are adjusted to the upper and lower end of the conductor bar 12 which is fixed between the supports 10, 10′. In this example the supports 10, 10′ have a cylindrical shape and are adapted to fix the conductor bar 12 between them. The conductor bar 12 is shown in a cross-section and has usually a length of several metres. The conductor bar 12 hereby is a conductor bar 12 of a rotor of a generator to produce power in the range of usually megawatts. In this certain example the rotor conductor bar 12 has two hollow profiles 22 which are provided as ducts for a cooling medium to flow through in operation of the generator. In the FIGS. the conductor bar 12 is removed from the notches of the rotor core for maintenance reasons and is therefore easily accessible. The tool 1 is brought adjacent to the conductor bar 12 which is shown in a schematic way comprising the rotating wheel 4 which has said arm 5 to support the wheel 4. The arm 5 is connected via an axis projecting through a hole or bushing in the wheel 4. The rotary bushing can be supplied by graphite powder or special alloys (e.g. Graphalloy) providing a long service time before maintenance is necessary. Alternatively, the wheel 4 can be attached to a ball 8 as a suspension as is described below in more detail. The material of the ball 8 has a low temperature conductivity and can be ZrO₂ or Al₂TiO₅. The axis of the movable wheel 4 is driven by an electric motor (not shown) comprised by the tool 1. The electric motor and the ends of the arm 5 far from the rotatable wheel 4 are accommodated in a housing 2, as can be seen in FIGS. 7, 8, 9. The material of the rotating wheel 4 can be high strength, high tensile, high temperature steel. Alternatively, the material of the rotating wheel 4 can be a composite material. The breadth of the rotatable wheel 4 is adjusted to fit between the supports 10, 10′ without touching the supports 10, 10′ in operation and impairing the running of the movable wheel 4 and damaging it. As is shown in FIG. 5 the counterpart 6 is positioned abut on the conductor bar 12 at the opposite side of the rotating wheel 4. The counterpart 6 is separate from the supports 10, 10′ in this example, not fabricated one-piece with the supports 10, 10′. The wheel 4 exerts a force at the conductor bar 12 and by this force the shape of the conductor bar 12 is changed, especially the height h of the conductor bar 12 is reduced.

In an example of the invention the movable wheel 4 of the tool 1 is designed with an imbalance thus performing an oscillation of the rotating wheel 4. By this means the force is applied to the conductor bar 12 as a kind of hammering with low amplitude. This means the wheel 4 conducts a bidirectional movement in the axial direction of the tool 1, indicated by the double sided arrow. This hammering movement may be the only movement the wheel 4 conducts. In a different example the wheel 4 additionally conducts a rotating movement around its axis. The third application is that the wheel 4 only conducts a rotating movement without a hammering or bidirectional movement. In addition to the force applied, heat and force are applied by the tool 1. To this end the tool 1 comprises a heat source 20, described under FIGS. 8 and 9. The temperature range of this heat application can be between 250° C. to 900° C., preferably approximately 500° C. As described in a preferred example the heat is generated by friction in the same temperature range. It has been found that a heat application of approximately 500° C. and above to the copper conductor bar 12 requires a much lower force to be applied. The necessary force for shaping is then only approximately 40 MPa compared to approximately 400 MPa with 100° C. or 200° C. The heat source 20 can be integrated in the tool 1 and can be based on high frequency induction, high current resistive or direct flame, e.g. by burning of fuel in a tank comprised by the tool 1. In a further example the tool 1 comprises a chemical tank to apply a chemical substance to the conductor bar 12. The heat source 20 can also comprise a plasma torch. In an alternative the heat source 20 is a separate part of the tool 1. An air-forced cooling device or similar cooling device can be arranged at the conductor bar 12 to cool down the conductor bar 12 after shaping, e.g. via the feed charge 13. By application of an anti-friction agent the sliding of the surface of the rotating wheel 4 along the surface of the conductor bar 12 is facilitated. In a further example rills 24 or a template is engraved or imprinted into the wheel 4 or roller to the end of imprinting the corresponding form or figure of the rills 24 or template into the surface of the conductor bar 12. To this end of imprinting the conductor bar 12 the tool 1 is designed in the hammering mode described above with a fixed wheel 4. The imprinting of rills 24 or a template leading to an uneven and structured surface can be useful for example to enlarge the cooling surface of the conductor bar 12 and thus to improve the cooling properties. Another aspect of this feature is to imprint rills 24 into the conductor bar 12 which are suitable to engage to spacers (not shown). These spacers are commonly placed between conductor bars 12 to create a distance space between the conductor bars 12. Applying these rills 24 for the spacers improves the mechanical properties of the conductor bars 12 with attached spacers.

The tool 1 is in an example equipped with at least one sensor suitable for measuring the speed of the movable wheel 4. An optional microcontroller is comprised by the tool 1 to control the speed measured by the sensor. The speed control of the tool 1 improves the quality and speediness of the method of shaping the conductor bar 12.

The tool 1 can be manufactured as a portable or handheld device. To this end the tool 1 has a grip projecting from the housing 2 by which an operator can carry and handle the tool 1 with both hands. As a handheld tool 1 the service scope is extended and the tool 1 is employed in a flexible way. Alternatively, the tool 1 is part of a robotized automation system. As part of this the tool 1 is embedded in a frame resting on the bottom with rolls to move the system to the place of work. Designed as an automation system the operator has not to carry the tool 1 but only to operate the automation system.

FIG. 6 shows a schematic side view similar to FIG. 6 with a second rotatable wheel 4 engaging the conductor bar 12 from the opposite side of the conductor bar 12 than the first rotating wheel 4 engaging from the left. The second rotatable wheel 4 having also arms 5 supporting the second rotatable wheel 4 and replacing the counterpart 6 in the first example under FIG. 1. In the configuration of FIG. 6 two equal tools 1 are provided accordingly which shape the conductor bar 12 in between from both sides.

Another example for achieving a variable sweep curve for the compressed hollow conductor, namely the conductor bar 12, is to apply at least two rotating counter wheels 4 next to each other instead of one shown in FIG. 7. The two rotating counter wheels 4 (not shown) have variable rotation amplitudes and/or rotation frequencies. All examples described provide a high speed shaping of conductor bars 12 to reduce the volume of the conductor bars 12 by reducing the height h of the conductor bar 12 along the length.

FIG. 8 shows a perspective view of an example of the tool 1 which can be handled manually by an operator. The tool 1 comprises a housing 2 to accommodate an electric motor with a power in the range of several kilowatts. The motor drives the ball 8 via a shaft 3 and the arms 5, 5′ made from ceramic in this example. The wheel 4 is hereby securely fixed to the ceramic ball 8 and thus follows the movement of the ceramic ball 8. The movement of the wheel 4 is corresponding to the other examples a bidirectional movement and/or a rotational movement.

FIG. 9 illustrates a perspective view similar to FIG. 8 showing the tool 1 in an operation mode. The tool 1 travels along the small face of the conductor bar 12 with hollow profile 22. The wheel 4 of the tool 1 is moved as described. Above the conductor bar 12 the heat source 20 is mounted to apply heat to the conductor bar 12. The application of heat by the heat source 20 and force by the driven wheel 4 leads to an even deformation of the rectangular conductor bar 12, such that the height h is reduced essentially without deforming the longer faces of the conductor bar 12. In this view again the height h is the dimension from left to right. A substantial reduction of the volume of the conductor bar 12 is achieved to fulfil the requirements of little space available in big size electric machines. To fabricate the ceramic ball 8 with the wheel 4, the wheel 4 has an opening in the middle which has a slightly smaller diameter than the diameter of the ball 8. The wheel 4 further is longitudinally divided in two sections.

FIG. 10 shows a schematic side view of an alternative example of the inventive tool 1. The tool 1 hereby has a hammer 7 serving for engaging to the conductor bar 12. In the contrary to the examples above no wheel 4 supported by arms 5, 5′ is provided, the shaping function is fulfilled by the hammer 7. The hammer 7 has a rectangular cross-section in this example. The hammer 7 conducts a bidirectional movement in the axial direction of the tool 1, no rotational movement is conducted hereby. Similar to the wheel 4 in the examples above the hammer 7 is at least at the front side made from a high tensile steel or a composite material or from a different material. The hammer 7 is designed at the far front end plane with a structure of rills 24 embossed or stamped into the plane. In FIG. 11 elevations are shown creating a rill 24 between each elevation. This means the front end of the hammer 7 has a surface structure s with rills 24. By a controlled movement of the tool 1 or the conductor bar 12 the surface structure s of the hammer 7 transfers the rills 24 or templates into the conductor bar 12. Thus, the surface structure of the conductor bar 12 is modified correspondingly at the face at which the tool 1 is applied. As in the examples above a heat source 20 is applied correspondingly to apply heat to the conductor bar 12. The imprinting of rills 24 or a template leading to a structured surface of the conductor bar 12 can be useful for example to enlarge the cooling surface of the conductor bar 12 and thus to improve the cooling properties. Another aspect of this feature is to imprint rills 24 into the conductor bar 12 which are suitable to engage to spacers (not shown). These spacers are used to ensure a certain distance between several adjacent conductor bars 12. A disk 25 is attached to the shaft 3 around the shaft 3. The disk 25 is fabricated out of a heat resistant material. The main function of the disk 25 is to shield the housing 2 of the tool 1 from heat generated by the tool 1 in operation.

FIG. 11 shows a schematic perspective view of the tool 1 according to FIG. 10 without conductor bar 12.

The tool 1 achieves as a main issue in connection with retrofit the increase of the power to volume ratio by shortening the end regions of the conductor bar 12. The term retrofit denominates the maintenance and rearrangement of conductor bar windings of turbogenerators in the technical field. Next to the reduction of the height h a reduction of the bending radii of the conductor bars 12 is achieved to reduce the volume and to make the electric machine or rotor more compact. The invention allows to avoid any fused parts or removal of material from the conductor bar 12.

FIGS. 12, 13, and 14 show schematic front views of a conductor bar 12. In FIG. 12 the conductor bar 12 is shown before shaping with a tool 1 or a method according to the invention. The hollow profile 22 captures a huge part of the inner space of the conductor bar 12. FIG. 13 shows a conductor bar 12 similar to FIG. 12 after shaping of the conductor bar 12. It can be seen that the hollow profile 22 is reduced, the space captured by the hollow profile 22 is diminished. Instead, the shaping has created a larger massive profile 23, the massive part of the conductor bar 12 is enlarged compared to FIG. 12. In addition, due to the shaping process the height h1 of the tooled conductor bar 12 is smaller than the height h0 of the unmachined conductor bar 12. Thus, the height h of the conductor bar 12 is modified. The modification of the conductor bar 12 is also illustrated and described in FIG. 1. FIG. 14 shows a conductor bar 12 similar to FIG. 13 after shaping. Besides the reduction of the height h also the surface structure of the upper face of the conductor bar 12 is changed. FIG. 14 shows for sake of illustration disproportionated rills 14 pressed into the surface of the conductor bar 12. The rills 14 are created by the tool 1 as described under FIG. 11 having a surface structure s with corresponding rills 24.

FIG. 15 shows a conductor bar 12 with a hollow profile 22 with two channels before shaping similar to FIG. 12. FIG. 16 shows a schematic front view of the conductor bar according to FIG. 15 after shaping. Hereby, the two hollow channels in the conductor bar 12 are kept after shaping. Only the height of the conductor bar 12 is reduced from h0 to h1. FIG. 17 shows a schematic front view of the conductor bar 12 according to FIG. 15 after shaping with a tool having a structure of rills similar to FIG. 14. In the example of FIG. 17 the two hollow channels persist even after shaping of the conductor bar 12 by means of the tool 1.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

### REFERENCE NUMBERS

Tool 1
Housing 2
Shaft 3
Wheel 4
Arms 5
Counterpart 6
Hammer 7
Ball or ceramic ball 8
Supports 10, 10′
Conductor bar 12
Feed charge 13
Slope 14
Plate 15
Channel 16
Heat source 20
Hollow profile 22
Massive profile 23
Rill 24
Disk 25

What is claimed is:

1. A tool for shaping a conductor bar for an electric machine, with a hammer or a movable wheel supported by arms, the hammer or the movable wheel are suitable for engaging and exerting force to the conductor bar to modify the height h and/or the surface structure of the conductor bar, whereas the hammer is adapted to conduct a bidirectional movement in the axial direction of the tool, whereas the wheel is adapted to conduct a bidirectional movement in the axial direction of the tool and/or a rotating movement, whereas the tool applies heat to the conductor bar by friction of the hammer or the movable wheel.

2. The tool according to claim 1, wherein the tool with the hammer or the wheel is movable in a direction along the conductor bar and in a direction perpendicular to the conductor bar along the axis of the wheel.

3. The tool according to claim 1, wherein a heat source produces and applies additional heat to the conductor bar in the range from 250° C. to 900° C., preferably approximately 500° C.

4. The tool according to claim 3, wherein the tool comprises a heat source operated by high frequency induction, high current resistive, or a flame.

5. The tool according to claim 1, wherein the hammer or the movable wheel oscillate in the axial direction of the tool creating a hammering effect to the conductor bar due to the oscillation.

6. The tool according to claim 1, wherein the tool is part of a robotized automation system.

7. The tool according to claim 1, wherein the tool is a handheld tool to be operated by an operator.

8. The tool according to claim 1, wherein the tool comprises a counterpart to create a counterforce to the conductor bar at the opposite side of the movable wheel.

9. The tool according to claim 8, wherein the counterpart is a second movable wheel.

10. The tool according to claim 1, wherein the surface of the hammer comprises rills or templates to be imprinted into the conductor bar.

11. The tool according to claim 10, wherein the rills in the surface structure of the hammer imprint rills into the conductor bar suitable to engage to spacers placed longitudinal between two conductor bars.

12. Method for shaping a conductor bar for an electric machine, the method comprising placing a conductor bar between supports, engaging at least one side of the conductor bar with a moving hammer or moving wheel, and shaping the conductor bar by means of the force applied by the moving hammer or moving wheel.

13. Method for shaping a conductor bar for an electric machine according to claim 12, wherein the shaping of the conductor bar is supported by heat generated by friction of the hammer or the movable wheel.

14. Method for shaping a conductor bar for an electric machine according to claim 12, wherein the conductor bar is fixed and the moving hammer or moving wheel is connected to and moved by a robot arm of a robot device along the conductor bar.

15. Method for shaping a conductor bar for an electric machine according to claim 12, wherein placing a counterpart at the opposite side of the conductor bar to apply a counterforce to the force applied by the moving hammer or moving wheel.

16. Method for shaping a conductor bar for an electric machine according to claim 13, wherein shaping the opposite side of the conductor bar with a second moving wheel at the same time.

17. Use of a tool according to claim 1 for shaping a conductor bar for an electric machine.
